(19) United States
(12) Patent Application Publication
(10) Pub. No.: US 2014/0326424 A1
(43) Pub. Date: Nov. 6, 2014

(54) ARC MELTING FURNACE APPARATUS AND METHOD OF ARC MELTING MELT MATERIAL

(71) Applicants: DIAVAC LIMITED, Chiba (JP); TOHOKU TECHNO ARCH CO., LTD., Miyagi (JP)

(72) Inventors: Motohiro Kameyama, Yachiyo-shi (JP); Yoshiaki Kawai, Yachiyo-dhi (JP); Yoshihiko Yokoyama, Sendai-shi (JP); Akihisa Inoue, Sendai-shi (JP)

(73) Assignees: TOHOKU TECHNO ARCH CO., LTD., Sendai-shi, Miyagi (JP); DIAVAC LIMITED, Yachiyo-shi, Chiba (JP)

(21) Appl. No.: 14/354,788

(22) PCT Filed: Aug. 9, 2012
(86) PCT No.: PCT/JP2012/070338

§ 371 Date: Apr. 28, 2014

(30) Foreign Application Priority Data
Nov. 2, 2011 (JP) 2011-241566

(51) Int. Cl. F27D 11/08; F27D 19/00

(52) U.S. Cl. CPC F27D 11/08; F27D 19/00; F27M 2003/13; F27D 2019/0003
USPC 164/4.1; 164/514; 164/154.2; 164/154.1; 75/10.65; 164/495

(57) ABSTRACT

The Present invention provides an arc melting furnace apparatus and a method of controlling arc discharge, in which a melt material having been melted can be stirred efficiently, avoiding labor intensive work. The furnace is provided with a mold 3 having a recess 3a and provided in a melting chamber 2, a non-consumable discharge electrode 5 for heating and melting a melt material accommodated in the recess 3a, a power source unit 10 for supplying electric power to the non-consumable discharge electrode 5, and a control device 11 which controls the power source unit to control output intensity of the arc discharge from the non-consumable discharge electrode. The control device 11 controls output current from the power source unit 10 and its current frequency to vary the output intensity of the arc discharge from the non-consumable discharge electrode 5 and stir a molten metal resulting from heating and melting the melt material.

### TECHNICAL FIELD

The present invention relates to an arc melting furnace apparatus and a method of arc melting a melt material, and to an arc melting furnace apparatus and a method of arc melting a melt material, which are suitably applied to melt materials, such as an alloy material, for example.

### BACKGROUND ART

The arc melting in which melt materials, such as a metal material (especially an alloy material), a ceramic material, etc., accommodated in a mold are melted using heat energy of arc discharge is conventionally and widely known.

This arc melting includes consuming type arc melting and non-consuming type arc melting. Among these, the non-consuming type arc melting employs a tungsten electrode as a cathode using a direct-current arc power source in an atmosphere of depressurized argon, and the melt material is melted between the cathode and the melt material (anode) placed on a water-cooled mold by means of the heat energy caused by direct-current arc discharge at a constant intensity.

FIG. 10 shows an example of a structure of a non-consuming type arc melting furnace using a conventional technique.

In an arc melting furnace 200 illustrated, a copper mold 201 is in close contact with a lower end of a melting chamber 210, and the melting chamber 210 is an airtight container. Further, a tank 202 in which cooling water circulates is formed under the copper mold 201. The copper mold 201 is a water-cooled mold. Furthermore, as shown, a cylindrical water-cooled electrode 203 is inserted from above the melting chamber 210 into the chamber, and a tungsten tip serving as the cathode is arranged to move upwards, downwards, forwards, backwards, leftwards, and rightwards by operating a handle part 204 in the melting chamber 210.

In this arc melting furnace 200, when melting metals to generate an alloy, a plurality of different weighed metal materials are first placed on the copper mold 201.

After exhausting air from the melting chamber 210 using a vacuum pump (not shown), an inert gas is introduced to provide an inert gas atmosphere (usually argon gas atmosphere); arc discharge is generated between the tungsten electrode (cathode) of the water-cooled electrode 203 and the metal material on the copper mold 201 (anode); the plurality of different metal materials are melted by the heat energy and alloyed. Such an arc melting furnace is disclosed in Patent Literature 1.

Incidentally, in an alloy generation method using such an arc melting furnace, since a metal having a large specific gravity tends to accumulate in the bottom of the alloyed material, it is necessary to thoroughly stir the alloy when in a molten state in order to generate an alloy having a uniform internal texture. Further, it is necessary to also stir a single substance thoroughly when in a molten state to obtain uniformity of a fine texture solidified.

However, since the melt material is melted on the water-cooled mold, the bottom of the molten metal in contact with the mold is cooled. Therefore, the melt located in the bottom changes from a liquid phase to a solid phase immediately, and sufficient stirring cannot be performed.

Thus, a method is used in which after cooling the melt material M having been melt, as shown in FIG. 11, the material (melt material) M is flipped on the copper mold 201 by a turning bar 205 (which is operated from outside of the melting chamber 210) and melted again; subsequently, cooling, flipping, and melting are repeated multiple times to carry out the mixing and equalize the fine texture and internal distribution of the ingredients of the material (melt material) M.

Further, in the arc melting furnace as disclosed in Patent Literature 2, a mount is attached to a base to be able to tilt rightwards, leftwards, backwards, and forwards, and the melting furnace is attached to the mount.

It is arranged that the above-mentioned mount is provided with a handle part for tilting this mount and the melting furnace is tilted by operating the handle part so as to rock and stir the melt material having been melted.

According to such an arc melting furnace, since the melting furnace can be tilted by operating the handle part, the melt material (molten metal) having been melted on the mold can be rocked to control its solidification and the melt material can be effectively stirred by further inclining and rocking the material.

### PRIOR ART LITERATURES

### Patent Literatures

Patent Literature 1: Japanese Patent Application Publication No. 2000-317621
Patent Literature 2: Japanese Patent Application Publication No. 2007-160385

### SUMMARY OF THE INVENTION

### Problems to Solved by the Invention

As described above, where the melt material having been melted is rocked and stirred using the turning bar, there is a problem in that troublesome work must be performed in which the turning bar is operated from outside of the melting chamber to hook and flip the material by means of a tip part of the turning bar a plurality of times, leading to poor workability and more working hours.

Further, when the melt material having been melted is rocked and stirred by operating the handle part provided for the mount and tilting the melting furnace, there is a technical problem of labor intensive work.

In order to solve the above-mentioned technical problems, the present inventors diligently studied rocking and stirring of the melt material based on a completely new idea, without rocking or stirring the melt material based on a conventional mechanical action. As a result, the present inventors have realized that the melt material having been melted can be agitated and stirred using external force produced by arc discharge, so that the present invention has occurred to the present inventors.

Further, the present inventors have found that vigorous rocking allows the molten metal to be thoroughly stirred and an amplitude of rocking this molten metal is greatly dependent on a frequency of discharge current, so that the present invention has occurred to the present inventors.

An object of the present invention is to provide an arc melting furnace apparatus and a method of controlling arc discharge, in which a melt material having been melted can be stirred efficiently, avoiding labor intensive work.

### Means for Solving the Problems

The arc melting furnace apparatus in accordance with the present invention made in order to solve the above-mentioned problems is an arc melting furnace apparatus comprising a mold having a recess and provided in a melting chamber, a non-consumable discharge electrode for heating and melting a melt material accommodated in the above-mentioned recess, a power source unit for supplying electric power to the above-mentioned non-consumable discharge electrode, and a control device which controls the above-mentioned power source unit to control output intensity of arc discharge from the above-mentioned non-consumable discharge electrode, characterized in that the above-mentioned control device controls output current from the above-mentioned power source unit and a current frequency to vary the output intensity of the arc discharge from the above-mentioned non-consumable discharge electrode and stir a molten metal resulting from heating and melting the above-mentioned melt material.

“Waveforms” of changing output intensity herein include a sine waveform, a rectangular waveform, a triangular waveform, a pulse waveform. By frequency we mean an inverse of period of intensity change of this output intensity.

As described above, the arc melting furnace apparatus in accordance with the present invention controls the output intensity i.e., the output current from the power source unit and its current frequency to allow the intensity change of the output of the arc discharge from the above-mentioned discharge electrode.

That is to say, the intensity of the output of the arc discharge is increased or decreased to give strong and weak forces produced by the arc discharge, so that the melt material having been melted is rocked and stirred. Due to the rocking and stirring, it is possible to obtain the material of a uniform texture, the alloy of uniform composition distribution, etc.

Here, it is desirable that the above-mentioned control device controls the above-mentioned output current from the above-mentioned power source unit and the above-mentioned current frequency so that the amplitude of shape change of the above-mentioned molten metal or the degree of variations in quantity of light reflected from the above-mentioned molten metal may be the maximum.

As described above, by controlling the output current from the power source unit and its current frequency, the output of arc discharge from the above-mentioned discharge electrode can be increased or decreased so that the amplitude of shape change of the molten metal or the degree of variations in quantity of light reflected from the above-mentioned molten metal may be the maximum; the melt material having been melted can be rocked and stirred more thoroughly. Due to the rocking and stirring, it is possible to obtain the material of a more uniform texture, the alloy of more uniform composition distribution, etc.

Further, it is desirable that a memory unit is provided for the above-mentioned control device, the above-mentioned memory unit has stored therein information data of the above-mentioned output current and the above-mentioned current frequency which are found in advance and allow the maximum amplitude of shape change of the molten metal or the maximum degree of variations in quantity of light reflected from the above-mentioned molten metal, and the above-mentioned control device reads the information data, stored in the above-mentioned memory unit, on the above-mentioned output current and the above-mentioned current frequency allowing the maximum amplitude of shape change of the molten metal or the maximum degree of variations in quantity of light reflected from the above-mentioned molten metal, and controls the above-mentioned power source unit based on the read information data on the above-mentioned output current and the above-mentioned current frequency.

As described above, by way of experiments etc., the above-mentioned output current and the above-mentioned current frequency are found in advance which provide the maximum amplitude of shape change of the molten metal or the maximum degree of variations in quantity of light reflected from the above-mentioned molten metal; the output of the arc discharge from the discharge electrode can be automatically increased or decreased by controlling the power source unit based on the output current and the above-mentioned current frequency.

Furthermore, it is desirable that a molten metal measurement means is provided which measures a shape change of the above-mentioned molten metal and outputs, to the above-mentioned control device, a detection signal according to the measured shape of the molten metal; by means of the detection signal inputted from the above-mentioned molten metal measurement means, the above-mentioned control device controls the output current from the power source unit and its current frequency according to the shape of the above-mentioned molten metal, to vary the output intensity of the arc discharge from the above-mentioned non-consumable discharge electrode.

As described above, by the detection signal inputted from the above-mentioned molten metal measurement means, the above-mentioned control device controls the output current from the power source unit and its current frequency according to the shape of the above-mentioned molten metal, to vary the output intensity of the arc discharge from the above-mentioned non-consumable discharge electrode, whereby the molten metal can vigorously be rocked and thoroughly stirred.

In particular, it is desirable to control the output current from the power source unit and its current frequency so that the shape change of the molten metal may be the maximum (rocking amplitude is the maximum) and to vary the output intensity of the arc discharge from the above-mentioned non-consumable discharge electrode. Further, the molten metal measurement means is provided which measures the shape change of the molten metal and outputs the detection signal according to the shape of the measured molten metal to the above-mentioned control device, to thereby allow labor-saving and melting in a short time.

Still further, it is desirable that the molten metal measurement means is provided which measures a variation in quantity of light reflected from the above-mentioned molten metal and outputs, to the above-mentioned control device, a detection signal according to the measured variation in quantity of light reflected from the molten metal; by means of the detection signal inputted from the above-mentioned molten metal measurement means, the above-mentioned control device controls the output current from the power source unit and its current frequency according to the quantity of light reflected from the above-mentioned molten metal, to vary the output intensity of the arc discharge from the above-mentioned non-consumable discharge electrode.

As described above, instead of the molten metal measurement means for measuring the above-mentioned molten metal shape change, it is possible to use the molten metal measurement means which measures the variation in quantity of light reflected from the molten metal and outputs the detection signal according to the measured quantity of light to the above-mentioned control device.

Here, “variations in quantity of light reflected from the molten metal” includes variation in quantity of light which is the arc discharge light reflected and returned from the molten metal, variation of radiating light from the hot melt material, etc.

Such quantity measurement of the reflected light is not exact with respect to evaluation of the rocking amplitude of the molten metal, but preferred, since it is possible to perform the measurement more easily at a higher speed with less costs than the shape measurement of the molten metal (for example, shape measurement using an image analyzing means).

It should be noted that, as for the above-mentioned control device, the output current from the above-mentioned power source unit and its current frequency are arranged to be controlled so that the amplitude of shape change of the above-mentioned molten metal or the degree of variations in quantity of light reflected from the above-mentioned molten metal may substantially be the maximum.

Further, it is desirable that the above-mentioned control device controls the current from the power source unit so that it may be single-sided repetition current.

Furthermore, it is desirable that a plurality of recesses are formed in the above-mentioned mold and a turning ring is provided which is moveably formed and turns the melt material in the recess of the above-mentioned mold. Thus, the melt material can be flipped easily by using the turning ring, and it is possible to obtain the material of a more uniform texture or the alloy of more uniform composition distribution etc., as well as to cope with automation in which the turning ring is operated using power.

Further, the method of melting the melt material in accordance with the present invention made in order to solve the above-mentioned problems is a method of melting a melt material by arc discharge from a non-consumable discharge electrode, characterized in that by changing output current, and its current frequency, which is supplied from a power source unit to the above-mentioned non-consumable discharge electrode, an output intensity of the arc discharge from the above-mentioned non-consumable discharge electrode is varied, and the above-mentioned melt material is heated and melted.

As described above, the method of melting the melt material in accordance with the present invention is carried out in such a manner that the output intensity of the arc discharge from the non-consumable discharge electrode is varied by the output current supplied and its current frequency.

That is to say, the output intensity of the arc discharge is varied to provide strong and weak forces produced by the arc discharge, and the melt material having been melted is rocked and stirred. Due to the rocking and stirring, it is possible to obtain the material of a uniform texture, the alloy of uniform composition distribution, etc.

Here, it is desirable that the output intensity of the above-mentioned arc discharge is varied by supplying single-sided repetition current to the non-consumable discharge electrode. By “single-sided repetition current” we mean one whose waveforms include a sine waveform, a rectangular waveform, a triangular waveform, a pulse waveform, etc., and whose maximum and minimum currents are both of negative values, i.e. the current value is not beyond the zero point and biased to the negative side.

Further, it is desirable that a method for melting a melt material in an arc melting furnace apparatus comprising a mold having a recess and provided in a melting chamber, a non-consumable discharge electrode for heating and melting a melt material accommodated in the above-mentioned recess, a power source unit for supplying electric power to the above-mentioned non-consumable discharge electrode, and a control device which controls the above-mentioned power source unit to control output intensity of arc discharge from the above-mentioned non-consumable discharge electrode, is characterized in that the above-mentioned control device changes the output current, and its current frequency, which is supplied from the power source unit to the above-mentioned non-consumable discharge electrode and varies the output intensity of the arc discharge from the above-mentioned non-consumable discharge electrode, and the above-mentioned melt material is heated and melted.

Here, it is desirable that the above-mentioned current frequency is varied a plurality of times within a predetermined frequency range by the above-mentioned control device, and an amplitude of shape change of the molten metal for each frequency or a degree of variations in quantity of light reflected from the molten metal is measured with a molten metal measurement means, so as to find a current frequency which allows the maximum amplitude of shape change of the above-mentioned molten metal or the maximum degree of variations in quantity of light reflected from the above-mentioned molten metal becomes the maximum, and the current frequency and output current which are in fixed ranges with respect to the thus found current frequency are supplied from the power source unit to the non-consumable discharge electrode for a predetermined time period so as to melt the melt material.

As described above, while performing the measurement by the molten metal measurement means, the current frequency at which the amplitude of shape change of molten metal becomes the maximum or the degree of variations in quantity of light reflected from the above-mentioned molten metal becomes the maximum is found. The output current having a current frequency within a fixed range with respect to the thus found current frequency is supplied from the power source unit to the non-consumable discharge electrode for a predetermined time period so as to melt the melt material. Thus, the melt material having been melted can be rocked more and stirred. Due to the rocking and stirring, it is possible to obtain the material of a more uniform texture, the alloy of more uniform composition distribution, etc.

Further, it is desirable that when the step of melting the above-mentioned melt material a plurality of times, a turning step of turning the melt material in the recess of the above-mentioned mold is carried out after the step of melting the above-mentioned melt material, then the step of melting the above-mentioned melt material is carried out again. Due to the turning step, it is possible to obtain the material of a more uniform texture, the alloy of more uniform composition distribution, etc.

Furthermore, it is desirable that the current frequency which is in the fixed range with respect to the above-mentioned found current frequency is within a range from the current frequency at which the amplitude of shape change of the molten metal is the maximum or the degree of variations in quantity of light reflected from the above-mentioned molten metal is the maximum to one that is 1.5 Hz lower than the current frequency.

As for determination of current frequency used for the melting the current frequency is gradually varied from a small frequency to a large frequency by a predetermined frequency range to find a frequency at which the rocking of the molten metal is the maximum. However, if it exceeds the current frequency at which the amplitude of shape change of the molten metal becomes the maximum or the degree of variations in quantity of light reflected from the above-mentioned molten metal becomes the maximum, the rocking of the molten metal decreases rapidly. Therefore, it is desirable that a current frequency within the range from the maximum current frequency to one that is 1.5 Hz lower than the maximum current frequency is the highest frequency (the optimal frequency) so that the maximum current frequency may not be exceeded due to an error etc.

### Effects of the Invention

According to the present invention, by varying the output intensity of the arc discharge, the power produced by the arc discharge is increased or decreased, so that the melt material having been melted can be rocked and can stirred. As a result, it is possible to obtain the material of a uniform texture, the alloy of uniform composition distribution, etc., carry out the melting operation efficiently, and avoid labor intensive work unlike a conventional arc melting furnace apparatus.

Further, in the present invention, by adding the turn step of turning the melt material using power, it becomes easy to manufacture a higher quality alloy etc. not manually but automatically.

### BRIEF DESCRIPTION OF THE DRAWINGS

FIG. 1 is a schematic diagram showing an arc melting furnace apparatus of a first preferred embodiment in accordance with the present invention.

FIG. 2 is a schematic diagram showing the arc melting furnace apparatus of a second preferred embodiment in accordance with the present invention.

FIG. 3 is a sectional view along line A-A of FIG. 2.

FIG. 4 is a schematic diagram for explaining a principle of arc discharge of one preferred embodiment in accordance with the present invention.

FIG. 5 is a graph showing a preferred example of the discharge current of the arc discharge in accordance with the present invention, and showing a wave where a sine wave current is added to constant current.

FIG. 6 is a graph showing another example of the discharge current of the arc discharge in accordance with the present invention, where the wave is a substantially rectangular wave.

FIG. 7 is a diagram showing a schematic structure of a control device in the arc melting furnace apparatus of the first and second preferred embodiments in accordance with the present invention.

FIG. 8 are pictures showing EPMA observations in Comparative Example 1. FIG. 8(a) shows a case where the number of turning operation is one, FIG. 8(b) shows a case where the number of turning operations is two, FIG. 8(c) shows a case where the number of turning operations is three, and FIG. 8(d) shows a case where the number of turning operations is four.

FIG. 9 are picture showing EPMA observations in Example 1. FIG. 9(a) is a picture showing a case where a melting time period is 10 minutes and FIG. 9(b) is a picture showing a case where a melting time period is 15 minutes.

FIG. 10 is a sectional view of a melting furnace using a conventional technique.

FIG. 11 is a sectional view showing a situation where the melt material is turned in the FIG. 10 melting furnace.

### BEST MODE FOR CARRYING OUT THE INVENTION

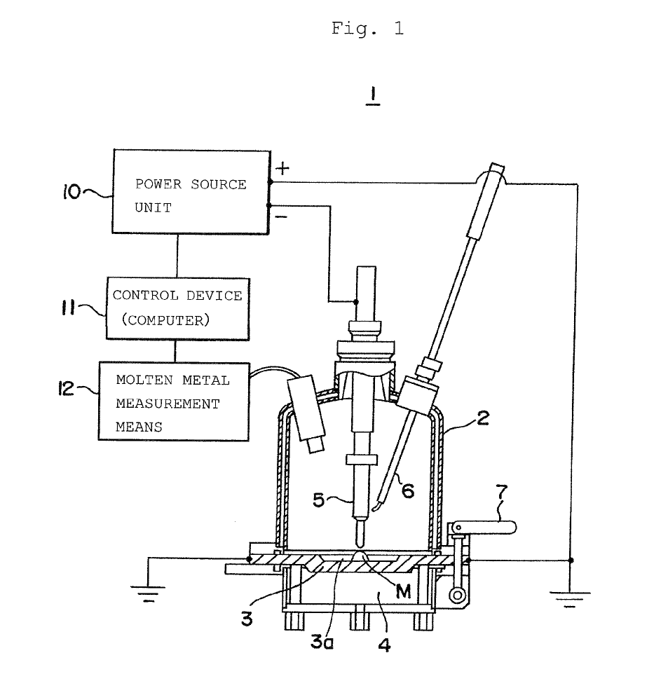

Hereinafter, an arc melting furnace apparatus 1 in accordance with a first preferred embodiment of the present invention will be described with reference to FIG. 1.

First, the whole structure of the arc melting furnace apparatus 1 of the preferred embodiment in accordance with the present invention will be described with reference to FIG. 1.

As shown in FIG. 1, in the arc melting furnace apparatus 1, a copper mold 3 is in close contact with a lower end of a melting chamber 2, and the melting chamber 2 is an airtight container. Further, a tank 4 in which cooling water circulates is formed under the copper mold 3. The copper mold 3 is a water-cooled mold.

Further, reference numeral 5 in the drawings indicates a cylindrical water-cooled electrode (non-consumable discharge electrode), and the water-cooled electrode 5 is provided with a tungsten tip part as a cathode, and is inserted into and from above the melting chamber 2.

The tungsten tip part of this water-cooled electrode 5 is disposed on the opposite side of an upper surface (recess 3a) of the copper mold 3. Further, the tip of this water-cooled electrode 5 is arranged to move upwards, downwards, forwards, backwards, leftwards, and rightwards by operating a handle part (not shown) in the melting chamber 2.

Further, the above-mentioned water-cooled electrode 5 is electrically connected with a cathode of a power source unit 10 so that electric power is supplied to the above-mentioned water-cooled electrode 5. Furthermore, an anode side of the above-mentioned power source unit 10 together with the melting chamber 2 and the copper mold 3 is grounded (earthed).

Still further, a vacuum pump (not shown) is attached to the above-mentioned melting chamber 2, and this vacuum pump can evacuate the melting chamber 2.

In addition, an inert gas feed section (not shown) is provided. After evacuating the melting chamber 2, inert gas is supplied from this inert gas feed section into the melting chamber 2 and enclosed therein so that the inside of the melting chamber 2 is in an inert gas atmosphere.

Yet further, a control device (computer) 11 is connected to the above-mentioned power source unit 10, and output current (intensity of current) from the power source unit 10 and its current frequency are controlled by the above-mentioned control device 11.

That is to say, by controlling the intensity and frequency of current from the power source unit 10, the output intensity of arc discharge is varied to give strong and weak forces produced by arc discharge. The strong and weak forces produced by the arc discharge rock and stir the melt material having been melted to provide an alloy etc. of materials having a uniform texture and uniform composition distribution.

Further, in this arc melting furnace apparatus 1, a molten metal measurement means 12 is provided which measures shape change of the molten metal of the melt material and outputs a detection signal according to the shape of measured molten metal to the above-mentioned control device 11.

In particular, image analysis of the shape of the molten metal is carried out with a CCD camera etc., and a detection signal according to a picture change (shape change) is sent to the control device. It is arranged that the output current (intensity of current) from the power source unit 10 and its current frequency are controlled by the above-mentioned control device 11 so as to give high and low output intensities of the arc discharge from the above-mentioned discharge electrode 5.

It should be noted that a light quantity sensor other than the CCD camera etc. can be used as the molten metal measurement means 12. In this case, it may be arranged that a variation in quantity of light reflected from the molten metal is measured by a light quantity sensor, and the detection signal according to the measured quantity of light reflected from the molten metal is sent to the control device to control the intensity of current from the power source unit 10 and its frequency.

Using this light quantity sensor is less expensive than in the case where the CCD camera is used, and it is possible to reduce the cost of the apparatus. Further, the measurement can be carried out more easily and at a higher speed than using the CCD camera.

Furthermore, a turning bar 6 operated from outside of the melting chamber 2 is provided and it is arranged that, after cooling the melt material having been melt, the material (melt material) M is flipped on the copper mold 3 (recess 3a) by the turning bar 6 from outside of the melting chamber 2.

In addition, in FIG. 1, reference numeral 7 indicates a lever for operating the lower end of the melting chamber 2. By operating this lever 7, the copper mold 3 at the lower end can be removed from the melting chamber 2, the melt material can be placed on the above-mentioned copper mold 3 (in the recess 3a), and the melt material can be taken out of the recess 3a.

When melting the thus arranged melt material in the arc melting furnace 1, firstly the weighed melt material is placed on the copper mold 3 (accommodated in the recess 3a).

Then, after allowing the inside of the melting chamber 2 to be an inert gas atmosphere (usually argon gas atmosphere), arc discharge is generated between the tungsten electrode (cathode) of the water-cooled electrode 5 and the melt material on the copper mold 3 (anode) to melt the melt material.

When producing an alloy, a plurality of metal materials are weighed and placed on the copper mold 3 (accommodated in the recess 3a). Then, in a similar manner as described above, after allowing the inside of the melting chamber 2 to be an inert gas atmosphere (usually argon gas atmosphere), arc discharge is generated between the tungsten electrode (cathode) of the water-cooled electrode 5 and the alloy material on the copper mold 3 (anode), and its thermal energy melts a plurality of different alloy materials, which are alloyed.

The arc discharge at this time is not performed at constant current, but the output current (intensity of current) and its current frequency are controlled, and the output intensity of the arc discharge from the above-mentioned water-cooled electrode 5 is varied, thus causing the output intensity to change. So-called external force is applied to the molten metal by the changing output of the arc discharge so that the metal material having been melted is stirred.

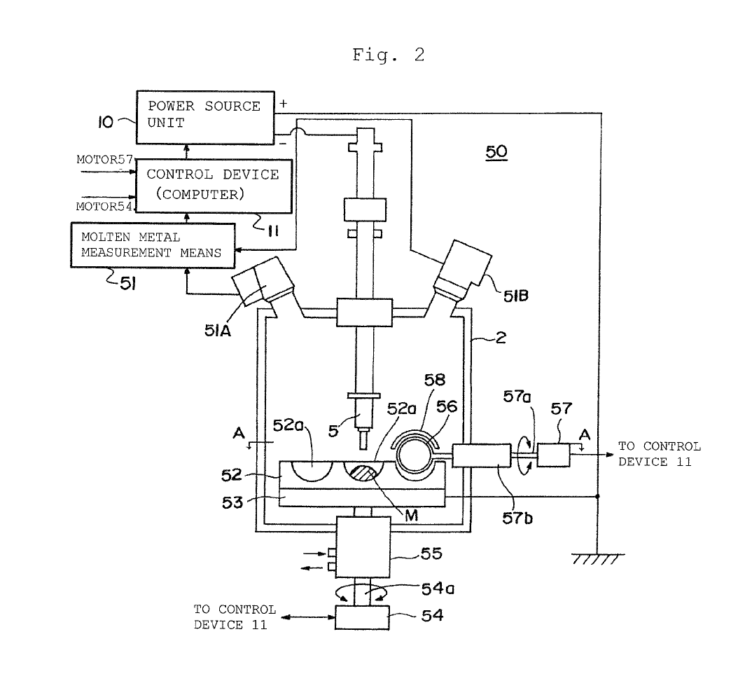

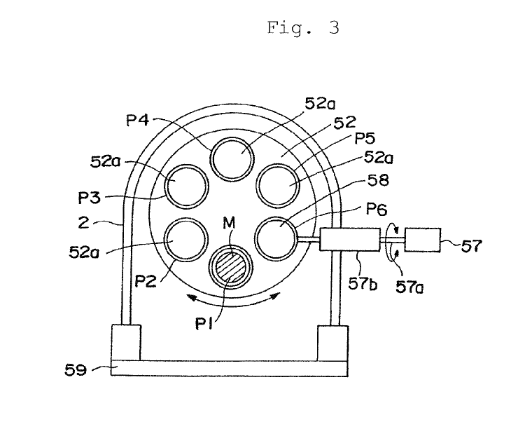

Next, the arc melting furnace apparatus in accordance with a second preferred embodiment of the present invention will be described with reference to FIGS. 2 and 3. It should be noted that like parts as in the arc melting furnace apparatus 1 in accordance with the first preferred embodiment are identified the same reference signs and the description of the parts will not be repeated.

An arc melting furnace apparatus 50 in accordance with this second preferred embodiment has formed a plurality of recesses 52a at an upper surface of the copper mold 52 (six recesses 52a are formed in the drawing) which are rotatable, thus being different from that of the first preferred embodiment. That is to say, a motor 54 is provided for the above-mentioned copper mold 52 and it is arranged to be rotatable about a drive shaft 54a. Further, a tank 53 through which cooling water circulates is provided under the copper mold 52 so as to introduce and discharge water through a rotary joint 55.

Further, the arc melting furnace apparatus 50 in accordance with this second preferred embodiment is different from that of the first preferred embodiment in that an automatic turning device is provided instead of the turning bar 6 of the first preferred embodiment.

This automatic turning device is arranged such that, after cooling the melt material having been melted, the material (melt material) is flipped on the copper mold 52 (recess 52a) by rotating the turning ring 56 by a motor 57 from outside of the melting chamber 2. In addition, reference sign 57a shows a drive shaft and reference sign 57b indicates a bearing. Reference numeral 58 indicates a hemispherical splash prevention device which prevents the melt material from splashing out of the recess 52a when the melt material is turned.

Further, a light quantity sensor (illuminometer) 51A and a CCD camera 51B are used as a molten metal measurement means 51. Either a detection signal from the light quantity sensor (illuminometer) 51A or a detection signal from the CCD camera 51B is sent to the control device, so that the intensity and frequency of current from the power source unit 10 are controlled. In this Example, a degree of shaking of the molten metal was measured using the light quantity sensor (illuminometer), and the CCD camera 51B was used for the purpose of visually observing the shaking behavior of the molten metal. It is separately confirmed that the shape of the molten metal can be found by image analysis using the CCD camera 51.

In this arc melting furnace apparatus 50, the weighed melt material is first accommodated in the recess 52a of the copper mold 52.

Then, a front door 59 of the arc melting furnace apparatus 50 is closed and the melting chamber 2 is closed so that the inside of the melting chamber 2 is evacuated with the vacuum pump (not illustrated). Subsequently, inert gas (usually argon gas) is supplied to allow the inside of the melting chamber 2 to be an argon gas atmosphere.

Further, in a position (discharge position) P1 as shown in FIG. 3, the melt material is melted by arc discharge from the water-cooled electrode 5. After melting, the copper mold 52 is rotated to move the melt material to a position P2. A new melt material is fed and melted in a position P1, then moved again to the position P2 after melting.

In this way, as the copper mold 52 is rotated, the melt material is moved to the position P1, the position P2, a position P3, a position P4, a position P5, and a position P6 in sequence.

The above-mentioned position P6 is one in which the melt material having been cooled is turned with the turning ring 56, then the turned melt material is returned to the position P1 again and re-melted.

The melt material having been re-melted moves from the position P1 to the position P2, the position P3, the position P4, the position P5, and the position P6 in sequence, then returns to the position P1 again and is re-melted. The more equalized melt material can be obtained by repeating the melting and turning operation several times.

It should be noted that, as with the arc melting furnace apparatus 1 in accordance with the first preferred embodiment, the above-mentioned arc discharge is not performed at constant current, but the output current (intensity of current) and its current frequency are controlled, and the output intensity of the arc discharge from the above-mentioned water-cooled electrode 5 is varied, thus causing the output intensity to change. So-called external force is applied to the molten metal by the changing output of the arc discharge so that the metal material having been melted is stirred.

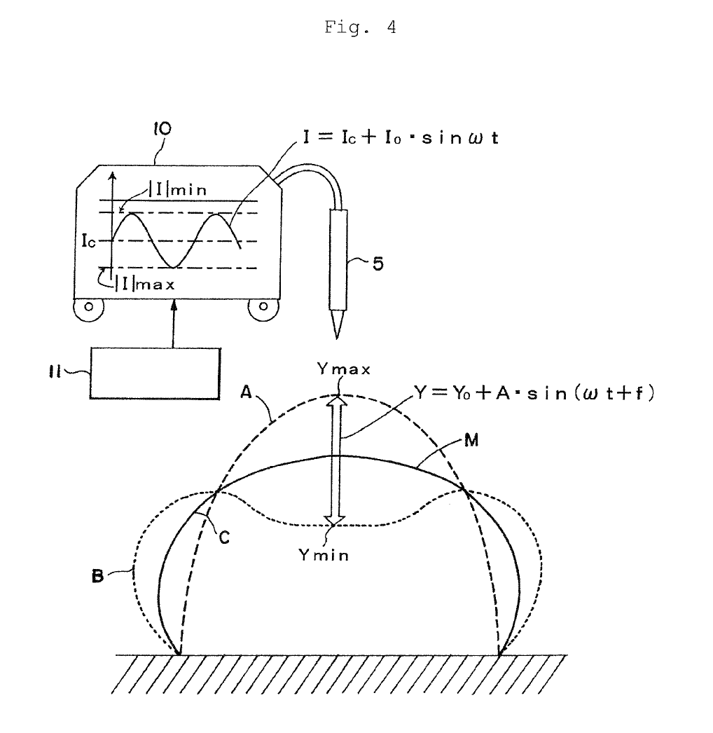

Next, in the arc melting furnace apparatus 1 in accordance with the first preferred embodiment above and the arc melting furnace apparatus 50 in accordance with the second preferred embodiment above, how the melt material having been melted by the variations of the output intensity of the arc discharge is rocked and stirred will be described with reference to FIG. 4.

First, the power source unit 10 is arranged to output constant current Ic, and it is arranged that the above-mentioned control device 11 controls the output current (intensity of current) from the above-mentioned power source unit 10 and its current frequency. That is to say, a control device 11 adds a sine wave having an amplitude Io to the constant current Ic and controls current I represented by:

I=Ic+Io·sin ωt (1)

to be supplied from the power source unit 10 to the water-cooled electrode 5 which performs the arc discharge.

It should be noted that the current I is represented by a negative value, since the water-cooled electrode is used as the cathode. Further, in the present invention, |Ic|>|Io| is a requirement as will be described later. That is to say, Ic is a negative value, Ic+Io<0 (negative value), and |Ic+Io| is the minimum absolute value of the current (current intensity). Similarly, |Ic−Io| is the maximum current intensity.

When such current is supplied to the water-cooled electrode 5, a force corresponding to a magnitude of current acts on the molten metal M of the melt material, the molten metal M of the melt material changes between a standing state A and a lying state B. The change of shape of this molten metal can be expressed with the following formula.

Y=Yo+A·sin(ωt+f) (2)

where Y is a change (change of shape) of the molten metal, Yo is a change (of shape) when force is not applied to the molten metal, A is an amplitude of the shape change (rocking) of the molten metal, and f is a phase difference. This phase difference f is caused by a visco-elastic characteristic of the molten metal, friction between the molten metal and the copper mold, etc.

That is to say, the melt material having been melted is rocked and stirred by the strong and weak forces produced by the arc discharge, to provide a uniform alloy etc. It should be noted that C in the drawing indicates a shape in the case where the value of current is an average value.

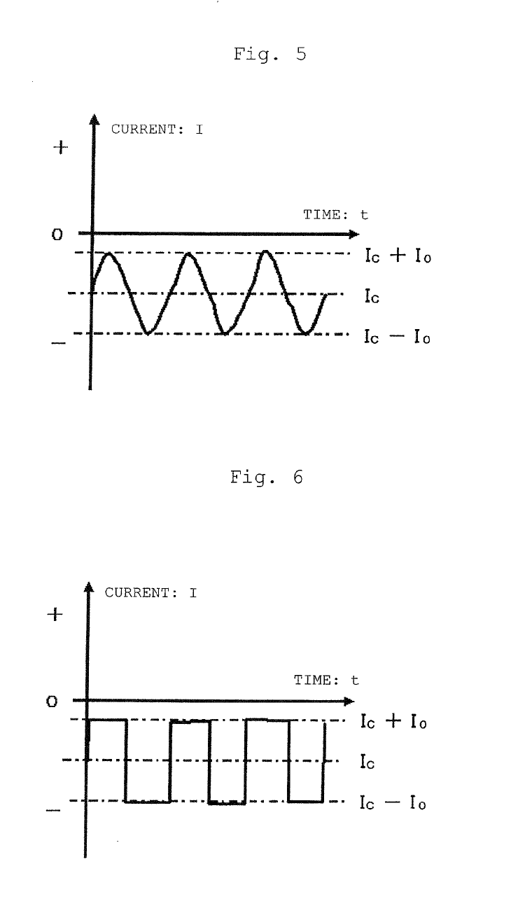

Further, the current I supplied to the water-cooled electrode 5 will be described with reference to FIG. 5. A horizontal axis shows time and a vertical axis indicates discharge current. Since the non-consumable discharge electrode is a cathode, the current value is negative in FIG. 5.

A wave of this discharge current is characterized by being single-sided (towards negative side) as shown in FIG. 5 and having strong and weak changes, and characterized in that when its modulated frequency is in agreement with a resonance frequency of the molten metal or it is close to the resonance frequency, the molten metal can be rocked efficiently.

This modulated frequency changes with materials, mass, etc., of the alloy etc. For example, as for 2 g of alloy (metallic glass), it is around 40 Hz. It is preferable that this modulated frequency is set as a value less than 50 Hz, which is smaller than a usual A/C frequency (frequency of 50 Hz or 60 Hz).

Thus, molten metal can be rocked efficiently by causing the discharge current to have a frequency smaller than that of the usual alternating current (frequency of 50 Hz or 60 Hz).

Further, both the current value Ic+IO and current value Ic−IO in FIG. 5 have the same sign (negative values in FIG. 5). As for the absolute values (strength of current), a value |Ic−IO| is lager and a value |Ic+IO| is smaller. That is to say, they are modulated to be strong or weak.

In the present invention, such discharge current is referred to as “single-sided repetition current.”

Further, as shown in FIG. 6, the waveform of this discharge current may be of a rectangular wave. Also in this case, as with the discharge current shown in FIG. 5, it is desirable to be single-sided (towards negative side) and provided with strong and weak changes. Further, it is desirable that the modulated frequency is set as a value of less than 50 Hz, which is smaller than the usual A/C frequency (frequency of 50 Hz or 60 Hz).

Comparison of the case where the waveform of this discharge current is of a rectangular wave and the case where the waveform is of a sine wave is such that a material having a poor wetting property with respect to copper molds, such as metallic glass, can increase the rocking amplitude of the molten metal in the case where the wave is a sine wave, and can judge whether a rocking state of the molten metal is good or not by means of a difference (gap) between a phase of the discharge current and a phase of the detection signal from the molten metal measurement means.

Further, there is a specific frequency (resonance frequency) at which the amplitude of the rocking molten metal M is the maximum, and the maximum rocking amplitude of this molten metal M is produced as the visco-elastic behavior of the molten metal and the frequency of the arc discharge resonate.

Therefore, at the specific frequency of “single-sided repetition current”, the molten metal M gives the maximum rocking amplitude, and the rocking of the molten metal becomes a mode which is near simple harmonic motion. Further, when a phase difference between the specific frequency (discharge cycle of arc discharge) of “single-sided repetition current” and the rocking cycle of the molten metal is around 90 degrees, the rocking amplitude of the molten metal is substantially the maximum.

As described above, since the stirring effect of the molten metal is increased when the rocking amplitude of the molten metal becomes the maximum, it is desirable to suitably choose the frequency of “single-sided repetition current” depending on the type of the molten metal (melt material) or the melting purpose.

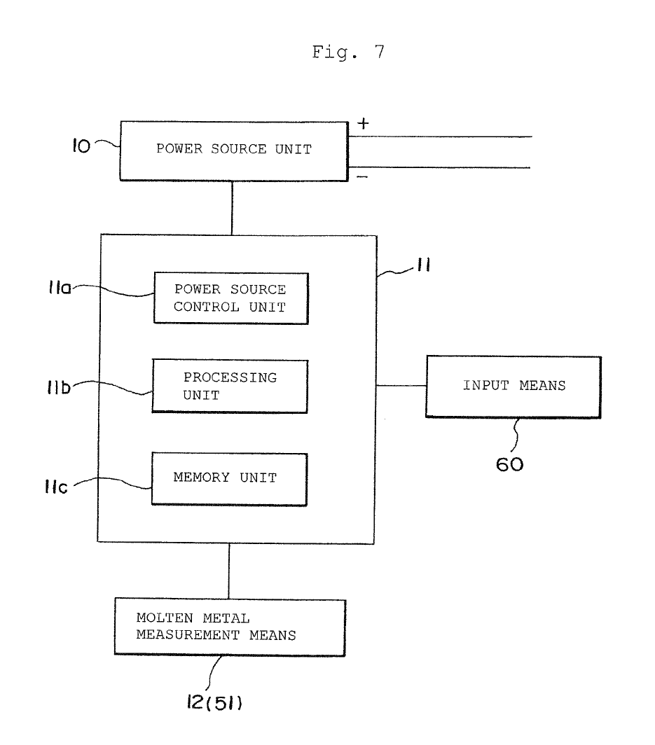

Now, as shown in FIG. 7, the control device 11 is provided with a power-source control unit 11a which controls the power source unit 10, a memory unit 11c having stored therein information data of type of the molten metal (melt material), melting information data, such as the maximum and minimum values of “single-sided repetition current” for every weight of each melt material for each repetition of melting, the frequency of “single-sided repetition current”, melting time, etc., and a program for operating the melting furnace, and a processing unit 11b which controls operation of the melting furnace based on the operation program, for the melting furnace, stored in the above-mentioned memory unit 11c, reads the above-mentioned melting information data, and provides the power source control unit 11a with the above-mentioned melting information data.

An input means 60 is provided for inputting, into the memory unit 11c, the information data on type of the molten metal (melt material), the melting information data, such as the maximum and minimum values of “single-sided repetition current” for every weight of each melt material for each repetition of melting, the frequency of “single-sided repetition current”, melting time, etc., which are obtained by carrying out experiments etc. in advance. Further, information data on an object to be melted is inputted through the input means 60.

Furthermore, when the information data on the type of the melt material to be melted and weight of each material of the melt material are inputted by this input means 60 and a signal for starting operation is inputted by the input means 60, the operation program for the melting furnace causes the processing unit 11b to obtain, from the memory unit 11c, the information data on the maximum and minimum values of “single-sided repetition current”, the frequency of “single-sided repetition current”, and melting time, which are most suitable for the first melting.

Still further, the processing unit 11b transmits the control signal to the power source control unit 11a, controls the power source unit 10 by means of the power source control unit 11a, and supplies the “single-sided repetition current” having a predetermined current value and frequency to the water-cooled electrode 5.

Then, similarly, based on the operation program for the melting furnace, the processing unit 11b obtains, from the memory unit 11c, the information data on the maximum and minimum values of “single-sided repetition current”, the frequency of “single-sided repetition current”, and the melting time, which are most suitable for the second melting and transmits the control signal to the power source control unit 11a. The control signal for controlling the power source unit 10 is transmitted from the power source control unit 11a, and the “single-sided repetition current” having a predetermined current value and frequency is supplied from the power source unit 10 to the water-cooled electrode 5.

After the melting is carried out predetermined times based on the operation program for the melting furnace, the melting operation is ended.

In addition, the above description is provided of the case where the memory unit 11c of the control device 11 has stored therein the information data of type of the molten metal (melt material), the melting information data, such as the maximum and minimum values of “single-sided repetition current” for every weight of each melt material for each repetition of melting, the frequency of “single-sided repetition current”, melting time, etc.

However, without obtaining the maximum and minimum values of the current and the frequency by an experiment etc. in advance, each time the melt material is melted, the frequency of the current is changed by a predetermined frequency range; the shape change and illumination change are measured with the molten metal measurement means 12 and 51, so as to find the frequency at which the maximum rocking amplitude or the maximum intensity of illumination are obtained. After finding the above-mentioned frequency, it is possible to carry out the melting for a predetermined time period at the frequency which allows the maximum rocking amplitude or the maximum intensity of illumination.

Further, for example, as to the alloy, surface tension and the visco-elastic properties of the molten metal change depending on the degree of mixing raw materials, so that the frequency at which the maximum rocking amplitude is obtained also changes with time.

As described above, each time the melt material is melted, the frequency of the current is changed by a predetermined frequency range, the shape change and illumination change are measured with the molten metal measurement means 12 and 51, so as to find the frequency at which the maximum rocking amplitude or the maximum intensity of illumination are obtained, thus automatically tracking the frequency at which the maximum amplitude change can be obtained, and carrying out automatic control. At the time when the frequency does not change, it is possible to determine that the “melting operation is completed.”

Furthermore, viscosity of the molten metal can also be estimated from attenuation behavior of the rocking amplitude (detection signal output from the molten metal measurement means) of the molten metal when stopping the arc discharge or when stopping addition of the sine wave current, while the sine wave current has been added to the constant current (see wave-like discharge current in FIG. 5).

The viscosity of the molten metal is an important value for evaluating the uniformity of the material, and it is possible to find the completeness of the melting process from the behavior of the viscosity value (or viscosity) changing as the melting operation proceeds.

As described above, the melting operation can be carried out efficiently, for example, by estimating the viscosity of the molten metal from the change of the frequency at which the maximum amplitude change of the molten metal is obtained and the attenuation behavior of the rocking amplitude of the molten metal (detection signal output from molten metal measurement means). Further, it is possible to judge the completion of the melting operation automatically.

### EXAMPLES

### Comparative Example 1

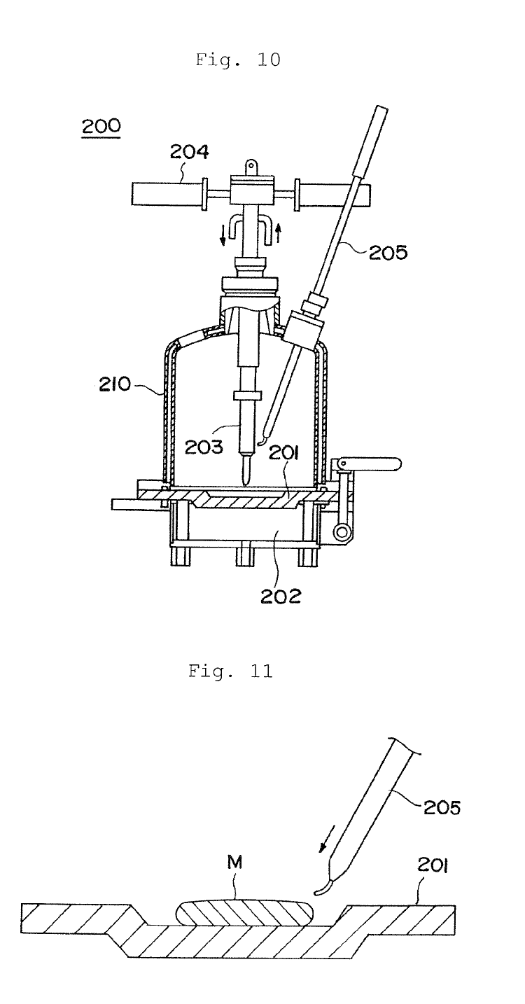

The following experiments were carried out using a conventional arc melting furnace as shown in FIG. 10.

As raw materials, Zr, Cu, Ni, and Al in an atomic ratio of 55:30:5:10 were accommodated in a recess provided for a copper mold 201 so that the total amount might be set to 25 g and it was evacuated. Evacuation was stopped at an ultimate vacuum of 2×10⁻³ Pa and high purity Ar gas was introduced up to 50 kPa.

Then, the raw materials were melted by arc discharge using a direct-current power source (constant current). Further, discharge was carried out for 5 minutes with a current rate of 300 A. While carrying out the discharge, a control lever 204 was operated so that the whole molten metal might be irradiated with arc.

After the first melting, the molten metal was left to stand and be cooled for 5 minutes. Upon solidification of the molten metal, using the turning bar 205, a raw alloy lump (apparently raw materials were mixed, but its internal composition might have large heterogeneity) was turned over, and then the arc melting operation similar to the above was performed to melt the row alloy lump by arc discharge from the back (with a current rate of 300 A for 5 minutes).

In this Comparative Example, an alloy subjected to the above-mentioned turning operation once, an alloy subjected to it twice, an alloy subjected to it 3 times, and an alloy subjected to it 4 times were prepared, and the surfaces were analyzed by EPMA (electron ray micro-analyzer) to check the homogeneity of the composition.

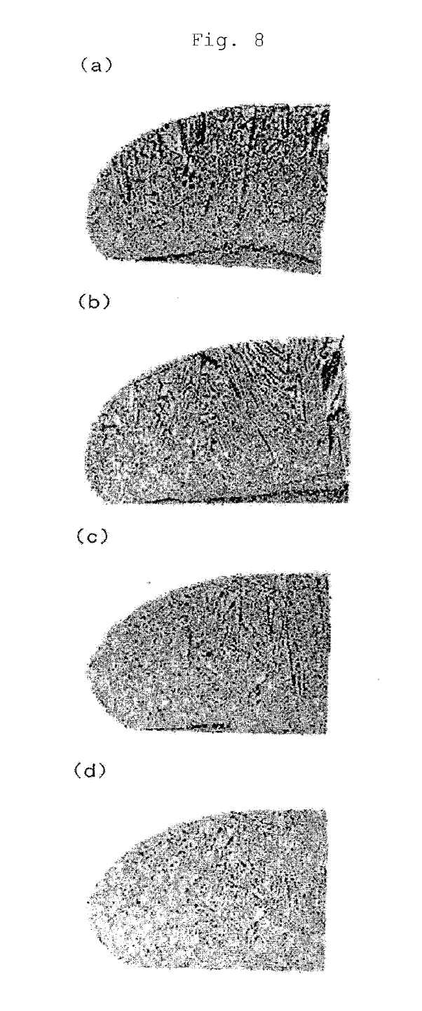

This analysis was carried out using halves obtained by cutting the alloy samples perpendicularly. Of four elements, Ni was observed to segregate considerably. The EPMA observation results showing the distribution of Ni are illustrated in FIGS. 8(a) to 8(d).

It should be noted that FIGS. 8(a) to 8(d) respectively show the sample turned once, the sample turned twice, the sample turned three time, and the sample turned four times.

In the pictures, a black portion is a part in which a lot of Ni elements have gathered. As can be seen from the pictures, in the case of fewer number of turnings, composition spots were large, the surface of the alloy lump had lots of wrinkles, and the surface was blurred significantly. When the number of turnings was four, it was confirmed that the alloy lump had a substantially satisfactory uniform composition and the surface also had a metallic luster.

Thus, in the conventional arc melting furnace, it is necessary to perform around four turnings. This case needs 40 minutes only for the standing and cooling time and melting time (discharge time) except turning operation time.

### Example 1

Using the arc melting furnace shown in FIG. 1, the current from the power source unit was arranged to be frequency controlled with a sine wave. A CCD camera was used as a molten metal measurement means.

As raw materials, Zr, Cu, Ni, and Al in an atomic ratio of 55:30:5:10 were accommodated in the recess provided for the copper mold so that the total amount might be set to 25 g and it was evacuated. Evacuation was stopped at the ultimate vacuum of 2×10⁻³ Pa and high purity Ar gas was introduced up to 50 kPa.

Then, the current to which the current of a sine wave was added was supplied from the power source unit 10 to the water-cooled electrode 5 and the raw materials were melted by the above-mentioned arc discharge.

In addition, at this time, the maximum current was 300 A, and the minimum current was 200 A. A frequency of the current was set to 12 Hz.

Further, after cooling the alloy material having been melted, the turning operation was carried out once in which a material M was flipped on a copper mold 3 by a turning bar 6 from outside of a melting chamber 2.

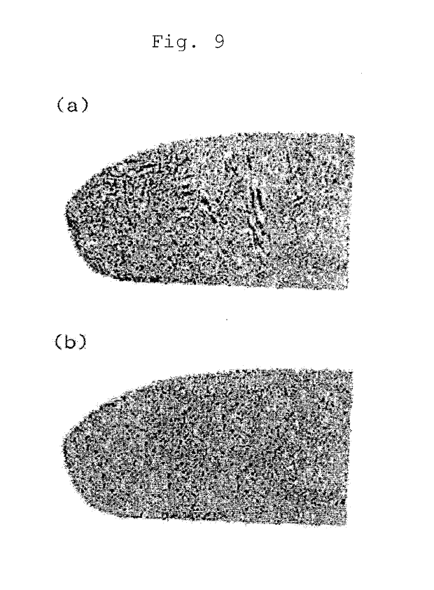

The arc discharge time periods before and after the flipping were the same, a surface state of the resulting alloy (sample) was visually observed (whether or not there was an uneven wrinkle-like portion), and cross-section EPMA surface analysis was carried out. The results of cross-section EPMA surface analysis are shown in FIG. 9. FIG. 9(a) shows a sample treated for 10 minutes, and FIG. 9(b) shows a sample treated for 15 minutes. Since all the treatments for 15 minutes or more provided the same surface analysis results as those in FIG. 9(b), illustration was omitted. As can be seen from FIG. 9, it is confirmed that the alloy of uniform composition can be obtained in the case where the total melting time before and after the flipping is 15 minutes or more.

Further, as for the gloss of the surface of the resulting alloy lump, the longer the melting time, the more shining. The treatments for 20 minutes, 25 minutes, and 30 minutes show no difference.

### Example 2

Using the arc melting furnace shown in FIG. 1, the current from the power source unit was arranged to be frequency controlled with a sine wave. The CCD camera was used as the molten metal measurement means.

As raw materials, Zr, Cu, Ni, and Al were used in an atomic ratio of 55:30:5:10. The following experiments were carried out for the materials respectively having the total amounts of 2 g, 3 g, 4 g, and 30 g.

Firstly, the above-mentioned raw materials were accommodated in the recesses provided for the copper mold, which were evacuated. Evacuation was stopped at the ultimate vacuum of 2×10⁻³ Pa and high purity Ar gas was introduced up to 50 kPa. Then, the current to which the current of a sine wave was added was supplied from the power source unit 10 to the water-cooled electrode 5 and the raw materials were melted by the above-mentioned arc discharge.

At this time, the maximum current was 300 A, and the minimum current was 200 A. The current from the power source unit was modified to have sine waves with frequencies 2 Hz, 5 Hz, 10 Hz, 20 Hz, 30 Hz, 40 Hz, 50 Hz, and 60 Hz. The turning operation was performed once and the melting time periods were respectively 7.5 minutes before and after the flipping operation, and the total time period was 15 minutes.

A surface state of the resulting alloy (sample) was visually observed (whether or not there was an uneven seam-like portion).

As a result, the alloys melted were most equalized respectively at 40 Hz in the case where the raw material is 2 g, at 30 Hz in the case of 3 g, at 30 Hz in the case of 4 g, and at 10 Hz in the case of 30 g; it was confirmed that the surfaces of the alloy lumps were glossy.

In addition, a value calculated assuming that a resonance frequency of the molten metal is in inversely proportional to a square root of mass is 42.6 Hz in the case where the raw material is 2 g. It is 34.8 Hz in the case of 3 g; 30.1 Hz in the case of 4 g; 11 Hz in the case of 30 g.

That is to say, according to the result of the surface gloss observation of the alloy lump, which is appropriate evaluation of the homogeneity of the above-mentioned alloy, it is confirmed that the molten metal can be rocked efficiently and suitable in the case where the modulated frequency is a frequency close to the resonance frequency of the molten metal or the same frequency as the resonance frequency of the molten metal.

### Example 3

Using the arc melting furnace shown in FIG. 1, the current from the power source unit was arranged to be frequency controlled with a sine wave. An illuminometer was used as the molten metal measurement means.

As raw materials, Zr, Cu, Ni, and Al were used in an atomic ratio of 55:30:5:10. The following experiments were carried out for the materials respectively having the total amounts of 15 g, 20 g, 25 g, 30 g, 35 g, and 40 g.

Firstly, the above-mentioned raw materials were accommodated in the recesses provided for the copper mold, which were evacuated. Evacuation was stopped at the ultimate vacuum of 2×10⁻³ Pa and high purity Ar gas was introduced up to 50 kPa. Then, as a first step, D/C current of a constant current of 300 A was supplied from the power source unit 10 to the water-cooled electrode 5 for 60 seconds to melt the raw materials by the above-mentioned arc discharge. Subsequently, the melt material was turned over.

As a second step, D/C current of a constant current of 300 A was supplied from the power source unit 10 to the water-cooled electrode 5 for 10 seconds, the raw material was melted by the above-mentioned arc discharge, and a first frequency search for a frequency suitable for melting was carried out. In this search, a start frequency was set to 8 Hz. While gradually increasing the frequency by 0.3 Hz, an amount of light reflected from the molten metal was measured with the illuminometer (frequency at the end of measurement was 13.7 Hz).

Then, a frequency at which a degree of variation in amount of light was the largest (frequency which provided the maximum amplitude) was found between a measurement start frequency of 8 Hz and a measurement end frequency of 13.7 Hz. It should be noted that the maximum current at this time was 350 A, and the minimum current was 250 A.

Further, the current was supplied from the power source unit 10 to the water-cooled electrode 5 for 120 seconds at a frequency allowing the largest degree of variation in amount of light (frequency which provided the maximum amplitude) to melt the raw materials by the above-mentioned arc discharge and then turn over the melt material after cooling.

Furthermore, as a third step, the D/C current of constant current rate of 300 A was supplied from the power source unit 10 to the water-cooled electrode 5 for 10 seconds, the raw materials were melted by the above-mentioned arc discharge, and a second frequency search for a frequency suitable for the melting was carried out. In this search, a start frequency was set to 8 Hz. While gradually increasing the frequency by 0.3 Hz, an amount of light reflected from the molten metal was measured with the illuminometer (frequency at the end of measurement was 13.7 Hz).

Then, a frequency at which a degree of variation in amount of light was the largest (frequency which provided the maximum amplitude) was found between a measurement start frequency of 8 Hz and a measurement end frequency of 13.7 Hz. It should be noted that the maximum current at this time was 350 A, and the minimum current was 250 A.

Further, the current was supplied from the power source unit 10 to the water-cooled electrode 5 for 120 seconds at a frequency allowing the largest degree of variation in amount of light (frequency which provided the maximum amplitude) to melt the raw materials by the above-mentioned arc discharge and then turn over the melt material after cooling.

That is to say, in the third step, the same step as in the above-mentioned second step i.e. the second frequency search was carried out to find the frequency at which a degree of variation in amount of light was the largest (frequency which provided the maximum amplitude). Then, after cooling, the melt material was melted and turned over.

Further, in a fourth step, the same step (a third frequency search) as in the above-mentioned second and third steps was carried out to find the frequency at which a degree of variation in amount of light was the largest (frequency which provided the maximum amplitude). Then, after cooling, the melt material was melted and turned over.

Furthermore, in a fifth step, the same step (a fourth frequency search) as in the above-mentioned second, third, and fourth steps was carried out to find the frequency at which a degree of variation in amount of light was the largest (frequency which provided the maximum amplitude). Then, after cooling, the melt material was melted and turned over.

In addition, Table 1 shows the maximum frequency (the maximum frequency which gives the maximum amplitude) at which the degree of variations in amount of light becomes large for each time for each sample weight. It should be noted that a unit is Hz.

TABLE 1

| | Sample | Sample | Sample | Sample | Sample | Sample |
|---|---|---|---|---|---|---|
| Number of | Weight | Weight | Weight | Weight | Weight | Weight |
| Searches | 15 g | 20 g | 25 g | 30 g | 35 g | 40 g |
| First Time | 11.3 | 10.7 | 9.8 | 8.9 | 8.6 | 8.9 |
| Second Time | 12.2 | 11.6 | 10.4 | 9.5 | 8.9 | 9.2 |
| Third Time | 12.5 | 11.3 | 10.7 | 10.1 | 9.8 | 9.5 |
| Fourth Time | 12.5 | 11.9 | 11.0 | 10.4 | 10.1 | 9.5 |

Further, Table 2 shows in detail the first and fourth search results (measured intensities of illumination) where sample weights are 15 g and 40 g. It should be noted that the amount of reflected light was measured using an illuminometer (T-10 type illuminometer manufactured by Konica Minolta, Inc.). An output voltage from the illuminometer is proportional to the amount of reflected light, and the degree of variations in amount of reflected light appears as the degree of variations of the output voltage from the illuminometer. The values in Table 2 are the degree of variations of the output voltages from this illuminometer (volt).

TABLE 2

| | | Sample | Sample | Sample | Sample |
|---|---|---|---|---|---|
| | Fre- | Weight 15 g | Weight 15 g | Weight 40 g | Weight 40 g |
| | quency | First | Fourth | First | Fourth |
| No. | Hz | Search | Search | Search | Search |
| 1 | 8.0 | 0.20 | 0.33 | 0.60 | 0.70 |
| 2 | 8.3 | 0.30 | 0.33 | 1.0 | 0.82 |
| 3 | 8.6 | 0.40 | 0.34 | 1.2 | 0.91 |
| 4 | 8.9 | 0.50 | 0.35 | 1.25 | 1.15 |
| 5 | 9.2 | 0.43 | 0.50 | 0.80 | 1.36 |
| 6 | 9.5 | 0.53 | 0.55 | 0.30 | 1.40 |
| 7 | 9.8 | 0.55 | 0.58 | 0.28 | 1.23 |
| 8 | 10.1 | 0.54 | 0.60 | 0.31 | 0.52 |
| 9 | 10.4 | 0.77 | 0.62 | 0.32 | 0.27 |
| 10 | 10.7 | 0.75 | 0.65 | 0.32 | 0.30 |
| 11 | 11.0 | 0.88 | 0.70 | 0.33 | 0.24 |
| 12 | 11.3 | 0.90 | 0.75 | 0.32 | 0.22 |
| 13 | 11.6 | 0.88 | 0.78 | 0.31 | 0.25 |
| 14 | 11.9 | 0.70 | 0.79 | 0.31 | 0.28 |
| 15 | 12.2 | 0.40 | 0.93 | 0.34 | 0.22 |
| 16 | 12.5 | 0.20 | 0.95 | 0.31 | 0.23 |
| 17 | 12.8 | 0.21 | 0.65 | 0.30 | 0.23 |
| 18 | 13.1 | 0.22 | 0.20 | 0.29 | 0.23 |
| 19 | 13.4 | 0.22 | 0.25 | 0.22 | 0.21 |
| 20 | 13.7 | 0.15 | 0.21 | 0.20 | 0.24 |

As can be seen from Table 2 above, when the frequency exceeds frequency which gives the maximum degree of variation in amount of reflected light (frequency giving the maximum degree of variation), the degree of variations in amount of reflected light (degree of variations of output voltage from illuminometer) tends to fall rapidly.

Therefore, in the actual arc melting process, in consideration of the error etc., it is preferable to subtract 1.5 Hz or less from the maximum frequencies shown in Table 1 and providing the large degrees of variations in amount of reflected light (the maximum frequency which gives the maximum amplitude). The frequencies shown in Table 3 and calculated by respectively subtracting around 0.5 Hz from those in Table 1 are used as the optimal frequencies in the experiment of the present Example.

TABLE 3

| | Sample | Sample | Sample | Sample | Sample | Sample |
|---|---|---|---|---|---|---|
| Number of | Weight | Weight | Weight | Weight | Weight | Weight |
| Searches | 15 g | 20 g | 25 g | 30 g | 35 g | 40 g |
| First Time | 10.8 | 10.2 | 9.3 | 8.4 | 8.1 | 8.4 |
| Second Time | 11.7 | 11.1 | 9.9 | 9.0 | 8.4 | 8.7 |
| Third Time | 12.0 | 10.8 | 10.2 | 9.6 | 9.3 | 9.0 |
| Fourth Time | 12.0 | 11.4 | 10.5 | 9.9 | 9.6 | 9.0 |

The thus found optimal frequencies can be stored in the memory means in the control device (computer) of the arc melting furnace and the stored optimal frequencies can be read to control the power source unit and melt the most preferred melt material.

Alternatively, it is possible to melt the melt material by controlling the power source unit by the above-mentioned optimal frequency, while finding the optimal frequencies as in the case shown in the present Example 3.

### EXPLANATION OF REFERENCE SIGNS

1 arc melting furnace apparatus
2 melting chamber
3 copper mold
4 tank
5 water-cooled electrode (non-consumable discharge electrode)
6 turning bar
7 lower end operating lever
10 power source unit
11 control device
12 molten metal measurement means
50 arc melting furnace apparatus
51 molten metal measurement means
51A illuminometer
51B CCD camera
52 copper mold
52a recess
53 tank
54 motor
55 rotary joint
56 turning ring
57 motor
58 splash prevention device
P1 melting position
P6 turning position

1. An arc melting furnace apparatus comprising a mold having a recess and provided in a melting chamber, a non-consumable discharge electrode for heating and melting a melt material accommodated in said recess, a power source unit for supplying electric power to said non-consumable discharge electrode, and a control device which controls said power source unit to control output intensity of arc discharge from said non-consumable discharge electrode, characterized in that
said control device controls output current from said power source unit and a current frequency to vary the output intensity of the arc discharge from said non-consumable discharge electrode and stir a molten metal resulting from heating and melting said melt material.

2. An arc melting furnace apparatus as claimed in claim 1, characterized in that said control device controls said output current from said power source unit and said current frequency so that an amplitude of shape change of said molten metal or a degree of variations in quantity of light reflected from said molten metal may be the maximum.

3. An arc melting furnace apparatus as claimed in claim 1, characterized in that a memory unit is provided for said control device, said memory unit has stored therein information data of said output current and said current frequency which are found in advance and allow the maximum amplitude of shape change of the molten metal or the maximum degree of variations in quantity of light reflected from the above-mentioned molten metal,
said control device reads the information data, stored in said memory unit, on said output current and said current frequency allowing the maximum amplitude of shape change of the molten metal or the maximum degree of variations in quantity of light reflected from said molten metal, and
controls said power source unit based on the read information data on said output current and said read current frequency.

4. An arc melting furnace apparatus as claimed in claim 1, characterized in that a molten metal measurement means is provided which measures a shape change of said molten metal and outputs, to said control device, a detection signal according to the measured shape of the molten metal; by means of the detection signal inputted from said molten metal measurement means, said control device controls the output current from the power source unit and its current frequency according to the shape of said molten metal, to vary the output intensity of the arc discharge from said non-consumable discharge electrode.

5. An arc melting furnace apparatus as claimed in claim 1, characterized in that a molten metal measurement means is provided which measures a variation in quantity of light reflected from said molten metal and outputs, to said control device, a detection signal according to the measured variation in quantity of light reflected from the molten metal; by means of the detection signal inputted from said molten metal measurement means, said control device controls the output current from the power source unit and its current frequency according to the quantity of light reflected from said molten metal, to vary the output intensity of the arc discharge from said non-consumable discharge electrode.

6. An arc melting furnace apparatus as claimed in claim 4, characterized in that said control device controls the output current from said power source unit and its current frequency so that the amplitude of shape change of said molten metal.

7. An arc melting furnace apparatus as claimed in claim 1, characterized in that said control device controls the current from the power source unit so that it may be single-sided repetition current.

8. An arc melting furnace apparatus as claimed in claim 1, characterized in that a plurality of recesses are formed in said mold and a turning ring is provided which is moveably formed and turns the melt material in the recess of said mold.

9. A method of melting a melt material by arc discharge from a non-consumable discharge electrode, characterized in that by changing output current, and its current frequency, which is supplied from a power source unit to said non-consumable discharge electrode, an output intensity of the arc discharge from said non-consumable discharge electrode is varied, and said melt material is heated and melted.

10. A method of melting a melt material as claimed in claim 9, characterized in that the output intensity of said arc discharge is varied by supplying single-sided repetition current to the non-consumable discharge electrode.

11. A method as claimed in claim 9, melting a melt material in an arc melting furnace apparatus comprising a mold having a recess and provided in a melting chamber, a non-consumable discharge electrode for heating and melting a melt material accommodated in said recess, a power source unit for supplying electric power to said non-consumable discharge electrode, and a control device which controls said power source unit to control output intensity of arc discharge from said non-consumable discharge electrode, characterized in that
said control device changes the output current, and its current frequency, which is supplied from the power source unit to said non-consumable discharge electrode and varies the output intensity of the arc discharge from said non-consumable discharge electrode, and said melt material is heated and melted.

12. A method of melting a melt material as claimed in claim 11, characterized in that said current frequency is varied a plurality of times within a predetermined frequency range by said control device, and an amplitude of shape change of the molten metal for each frequency or a degree of variations in quantity of light reflected from the molten metal is measured with a molten metal measurement means, so as to find a current frequency which allows the maximum amplitude of shape change of said molten metal or the maximum degree of variations in quantity of light reflected from said molten metal, and
the current frequency and output current which are in fixed ranges with respect to the thus found current frequency are supplied from the power source unit to the non-consumable discharge electrode for a predetermined time period so as to melt the melt material.

13. A method of melting a melt material as claimed in claim 12, characterized in that said current frequency is varied a plurality of times within a predetermined frequency range by said control device, and the amplitude of shape change of the molten metal for each frequency or the degree of variations in quantity of light reflected from the molten metal is measured with the molten metal measurement means, so as to find a current frequency which allows the maximum amplitude of shape change of said molten metal or the maximum degree of variations in quantity of light reflected from said molten metal, and
a step is carried out a plurality of times in which the current frequency and output current that are in fixed ranges with respect to the thus found current frequency are supplied from the power source unit to the non-consumable discharge electrode for a predetermined time period so as to melt the melt material.

14. A method of melting a melt material as claimed in claim 13, characterized in that when the step of melting said melt material a plurality of times, a turning step of turning the melt material in the recess of said mold is carried out after the step of melting said melt material, then the step of melting said melt material is carried out again.

15. A method of melting a melt material as claimed in claim 14, characterized in that the turning operation in said step of turning is carried out automatically using power.

16. A method of melting a melt material as claimed in claim 12, characterized in that the current frequency which is in the fixed range with respect to said found current frequency is within a range from the current frequency at which the amplitude of shape change of the molten metal is the maximum or the degree of variations in quantity of light reflected from said molten metal is the maximum to one that is 1.5 Hz lower than the current frequency.

17. An arc melting furnace apparatus as claimed in claim 5, characterized in that said control device controls the output current from said power source unit and its current frequency so that the degree of variations in quantity of light reflected from said molten metal may be the maximum.

18. A method of melting a melt material as claimed in claim 13, characterized in that the current frequency which is in the fixed range with respect to said found current frequency is within a range from the current frequency at which the amplitude of shape change of the molten metal is the maximum or the degree of variations in quantity of light reflected from said molten metal is the maximum to one that is 1.5 Hz lower than the current frequency.
